(19) United States
(12) Patent Application Publication
(10) Pub. No.: US 2024/0386311 A1
(43) Pub. Date: Nov. 21, 2024

(54) SELF-EVOLVING VIRTUAL TWINS

(71) Applicant: Bank of America Corporation, Charlotte, NC (US)

(72) Inventors: Sakshi Bakshi, New Delhi (IN); Savitri Podal, Mumbai (IN); Lalbahadur Gupta, Maharashtra (IN); Durga Khuttumolu, Telangana (IN)

(21) Appl. No.: 18/199,431

(22) Filed: May 19, 2023

(51) Int. Cl. G06N 20/00

(52) U.S. Cl. CPC G06N 20/00

(57) ABSTRACT

A digital twin system including a bot is provided. The bot may include an Interactive Voice Response system (IVR), a processor in electronic communication with the bot, and an electronic database. The database may be used for storing legacy e-mail information associated with at least a portion of an individual's electronic communications. The processor may be configured to flag a plurality of relevant components from the legacy e-mail information. The plurality of relevant components may include response information that may be used to, later in time, provide voice overs. The processor may further be configured to transmit the flagged plurality of relevant components for updating a virtual-twin model, identify a future voice over opportunity, and implement the plurality of flagged components with respect to said future voice over opportunity. The implementing may include using the flagged components in responding to the future voice over opportunity.

### FIELD OF TECHNOLOGY

Aspects of the disclosure relate to the creation of digital twins.

### BACKGROUND OF THE DISCLOSURE

In an organization, cognitive decision of information security team, production support team, executives and chief officers mostly dependent on different type of data. Such data may include legacy e-mails, reports and decision-rule engines. Currently, the process of getting data reports from different sources is either manual or semi-automated.

Therefore, a considerable amount of time is required to collate the data and make cognitive decisions. Sometime the data is highly restricted, confidential such as customer data, marketing strategy, etc. Decisions have to be timely and accurate.

It would be desirable to leverage Artificial Intelligence (AI) and Machine Learning (ML) to form a digital twin for a decision-maker.

As such, it would be further desirable to form a digital twin decision-maker such that the digital twin decision-maker could be self-evolving—i.e., could learn from present and future interactions in order to improve its decision-making process.

### SUMMARY OF THE DISCLOSURE

A method for providing a virtual-twin model of an individual is provided. The virtual-twin model may be used with an Interactive Voice Response (IVR) system and be implemented as part of a bot. The method may include mining or otherwise deriving legacy e-mail information from an electronic database. The e-mail information associated with an individual. The method may also include flagging a plurality of relevant components from the legacy e-mail information. The plurality of relevant components may include response information corresponding to future voice overs for using in simulating a voice of the individual. The method may also include transmitting the flagged plurality of relevant components to the bot for updating the virtual-twin model and identifying a future voice over opportunity. Finally, the method may, in certain embodiments, implement the plurality of flagged components with respect to the future voice over opportunity. The implementing may also include using the flagged components in responding to the future voice over opportunity.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows a schematic diagram of an apparatus in the prior art;

FIG. 4 shows another schematic diagram of another apparatus in accordance with principles of the disclosure; and

FIG. 5 shows still another schematic diagram of another apparatus in accordance with principles of the disclosure.

### DETAILED DESCRIPTION OF THE DISCLOSURE

AI learning models are preferably used to initiate the learning aspect of the decision making process based on legacy behavior of the cognitive entity. This legacy behavior may be derived with help of the different data sources such as customer survey data.

Such an AI model preferably creates graphical binary files which would be fed to an XR server to create digital twins in an XR environment. These digital twins preferably perform as live twins with voice over in a virtual platform to respond to any queries. For the purpose of this application, the term “voice over” should be understood to refer to using a synthetically created voice (based on real voice files) that could be used to splice with, add on to, add in line, or otherwise use in order to reproduce the voice of the user who's voice is being replicated.

The proposed solutions preferably provide necessary data/reports/analytics on-the-fly—i.e., in real time—in an XR environment. With the help of a digital twin, the cognitive entity can have the reports on-the-fly and digital twins can assist the cognitive entity in the decision-making process. This is true especially because the AI-trained digital twin has the same access as the cognitive entity.

In embodiments according to the disclosure, digital twins would preferably be self evolving which means it could learn and improve the decision-making process and/or behavior over the time. The digital twin can preferably auto-correct the decision, provide voice-overs or other useful information based on previous historical data.

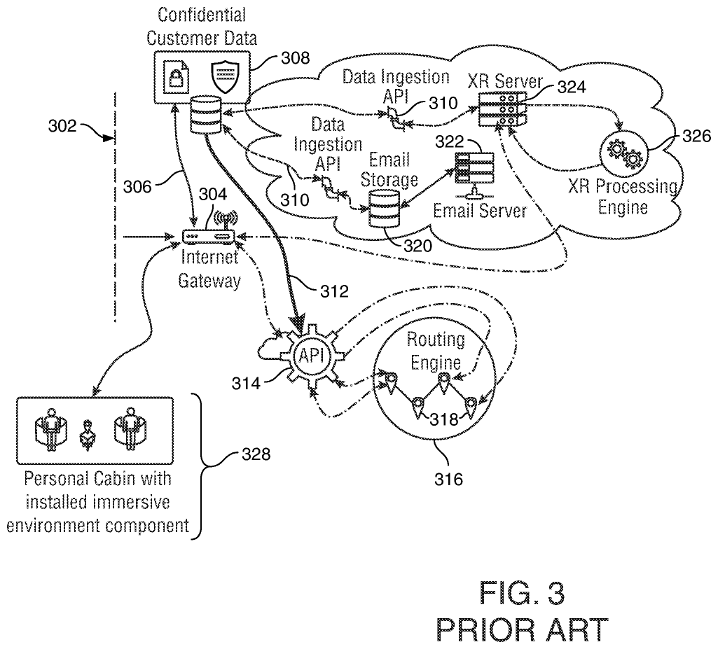

In some embodiments, the digital twin can process the workflow ahead with the decision for low-impact or medium-impact items independent of the intervention of the actual twin—i.e., the cognitive entity. Since it is integrated with XR, actual voice and visuals of the twin will be heard and seen. The following eight aspects show the advantages of embodiments according to the disclosure that overcome issues associated with the prior art systems and methods shown below in connection with FIG. 3.

1) The AI models are self-evolving as real time data fed to the model.

2) With the help of digital twins, cognitive actors can interact with each other in secure virtual environment;

3) AI Generated multi-model system is configured to get trained on historical communication behavior from emails data, in-store data, online sales data, web analytics data, and any other suitable data, that has been received from different upstream sources;

4) A model according to the embodiments may generate XR-fully assembled Graphical Language Binary files, which can act as a live twin with voice over of any team individual, in a virtual platform to respond back to any queries;

5) Source data collected from various sources such as Email, customer service data, IoT data etc. and all data can preferably be treated using pre-processing and an analytical engine. Then, data trained on transformer model (GPT Neo) may be used to generate insights (based on the several inputs and a historical DB email the data model) such that the twin can predict one or many actions that may be taken by team/individuals;

6) In certain embodiments, the model generates GLB (Graphic Library Binary scripts) with multilingual GPT C Model with the help of historical GLB file pattern and voice over patterns of several team individuals;

7) The model may generate avatar captions with the help of GPT Neo model for voice during live interaction and different visual views with the help of multi-modal transformer with multi visual algorithms (3D visuals are created based on query context such as for customer data representation several charts or graphs shown in 3D environment. 3D projection views in XR changes with context of query); and

8) The model may include responses to queries that can be sent to live XR Devices with the help of API.

The API may be used to make the system pluggable in preferably any XR environment. One preferable target method is to transmit the action and response for the user in virtual environment based on the restricted data access and the user's decision making history patterns. Such an AI model creates graphical binary files which would be fed to the XR server to create a digital twin in an XR environment. This digital XR twin can act as user's alter ego in the virtual environment.

One aspect of the embodiments relates directly to an AI generated multi-modal system which can be trained on a user's historical communication and decision-making behavioral patterns. Such a model may be based more on email responses to the user received from multiple upstream system of records.

The model may generate GLB Scripts using Multilingual GPT-C model which is used to re-train the model on GLB file Patterns and voice over patterns.

The model may also generate fully-assembled Graphical Language Binary files using multimodal transformer with avatar captions for voice over during live interaction and using multi-view visuals algorithm (Faster R-CNN−Glove+LSTM) which act as a live twin in a virtual environment for the user.

A digital twin system in electronic communication with a bot is provided. The digital twin system may include, or form part of, an Interactive Voice Response system (IVR).

The system may include a processor and an electronic database. The electronic database may, under the instructions of the processor, store legacy e-mail information associated with an individual's electronic communications.

The processor may be configured to flag a plurality of relevant components from the legacy e-mail information. The plurality of relevant components may include response information corresponding to future voice overs. The processor may transmit the flagged plurality of relevant components to the bot for updating the virtual-twin model.

The processor may be operable to identify a future voice over opportunity and implement the plurality of flagged components with respect to the future voice over opportunity, as follows. The implementing may include using the flagged components in responding to the future voice over opportunity.

The processor may be further configured to instantiate the plurality of flagged components as extended reality (XR)-fully-assembled graphical language binary files.

The processor may also be configured to flag based on sentiment analysis of the plurality of relevant components from the legacy e-mail information and tune the response information corresponding to future voice overs based, at least in part, on the sentiment analysis.

A formation of the digital twin may include, at least in part, flagging the plurality of relevant components from the legacy e-mail information. The processor may be further configured to tag the digital twin to a specific entity.

In certain embodiments, the processor may be further configured to use the digital twin to form unique sequences of information associated with the specific entity.

In some embodiments, the processor may be further configured to index the digital twin based on generated metadata tags. And the processor may be yet further configured to correspond the metadata tags to an initial response flag. The initial response flag may be formed using the flagging the plurality of relevant components.

In certain architectures, the processor may be further configured to bridge the response information, using an internet gateway, from a wearable device to a plurality of cloud-based extended reality (XR) servers.

The following figures and associated written specifications set forth the invention in additional detail to the foregoing.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

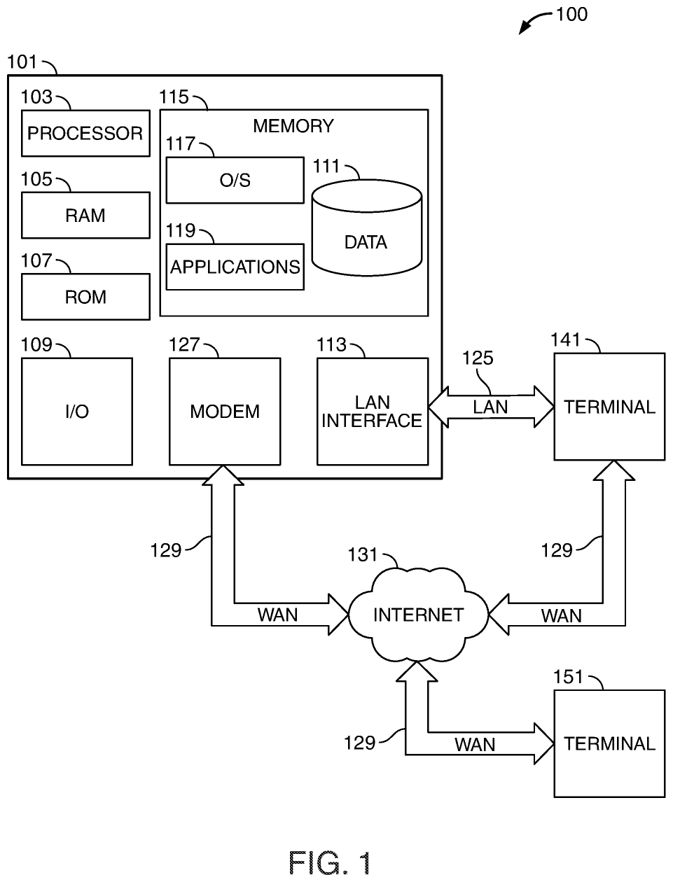

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

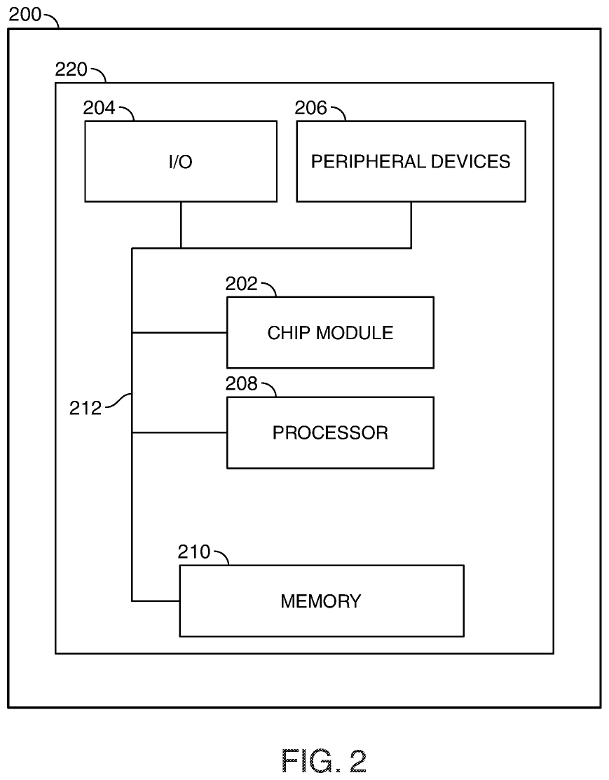

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

FIG. 3 shows a schematic diagram of an apparatus that exists in the prior art. At 302, systems of record (SOR) are shown. Data can be procured through multiple data systems within the SOR 302. The data can be heterogeneous in nature. These data systems can vary from in-store and online sales data, web browsing data, survey data, customer service datasets, advertising platforms, web analytics logs, marketing automation platforms, loyalty data, mobile app data, legacy data systems to data from IoT and wearable devices.

An internet gateway is shown at 304. Internet gateway 304 works as an edge device(s) to consume data from multiple SORs and transmit the data packets to one or more relevant stream(s). The data is pushed in packets of information, thereby maintaining the data security and eliminating noise from environmental signals.

Internet gateway 304 is shown as connected via communication line 306 to customer confidential data store 308 (which may be implemented in the form of one or more databases). The customer data along with any other non-public information that is sensitive in nature may be masked accordingly. The masked data generates corresponding unmasking keys that are stored and retrieved in a secured manner for information processing.

The customer data may be stored in a distributed manner and in sorted order. Customer data sorting helps in quick data retrieval and processing while matching the unmask key match.

Data ingestion 310 typically involve live streaming application programming interfaces (APIs). These APIs are interconnected to balance the loads and parallel processing throughout the apparatus shown in FIG. 3.

Data hosting 312 may be administered through the live streaming APIs 314 and may be implemented in cloud 316. Distributed cloud nodes 318 in cloud 316 host data and relevant processing engines for the data. Internally, through the web 3.0 cloud, or other suitable network, the data processing is managed by subsequent API networks. The data transfer from and through cloud 316 is preferably conducted in real-time and provides relevant input to the inline engines for information processing and artificially-intelligent decision making.

E-mail storage is shown at 320. For data processing and data masking, relevant notifications are sent across the network. These notifications may also correspond to the key for unmasking the data at the site target. Any e-mails processed through the internal system or received from any external system are processed within the e-mail storage system 320. These e-mail storage systems are typically also hosted on web cloud 316.

More specifically, e-mail storage systems include e-mail server 322. E-mail server 322, typically hosted on the cloud, is the backbone of the email system and is preferably highly secured with authentication layers for information retrieval. E-mail servers 322 host data from all the executives and archive the e-mail history for training AI model.

Extended reality (XR) server 324 is preferably in communication with XR processing engine 326. XR technology, within the context of this application, is intended to combine or mirror the physical world with a “digital twin world” with which it is able to interact.

Personal cabin 328 is shown as well. Personal cabin 328 preferably includes an installed immersive environment component. Such an environment preferably promotes more accurate and noise-free input from a user, because it limits external sources of sound and visual input. The cabins may be installed with immersive components to give a secured virtual space for conducting and communicating with the digital twin and may overcome virtual XR requirements. XR edge devices may be used to create the virtual environment and process the information for seamless transmission. These devices can preferably interlink to one another for any entity-to-entity connection (e.g., executive-to-executive) in the virtual space as well.

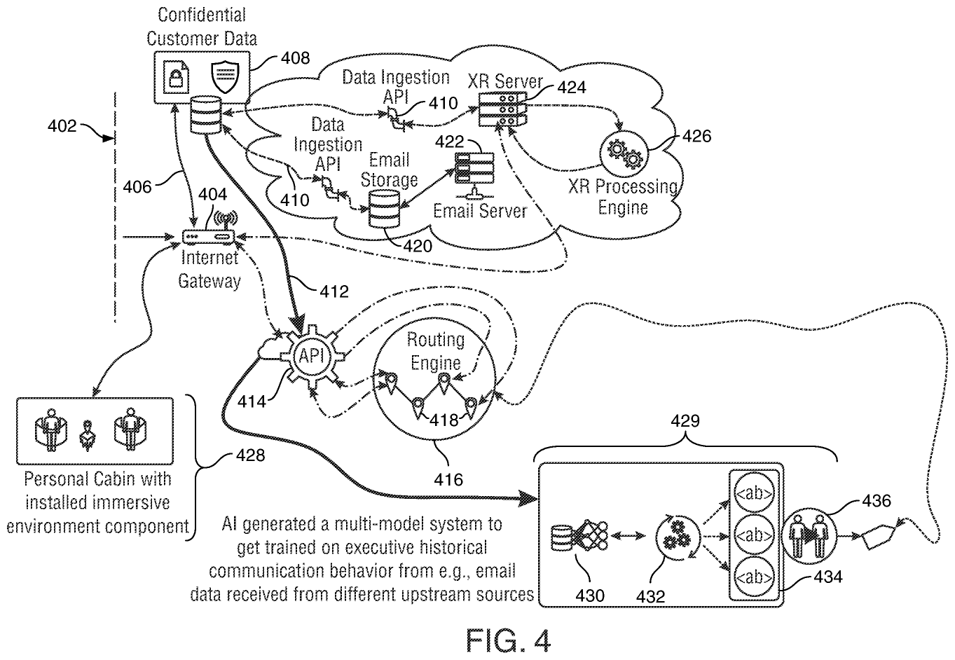

FIG. 4 shows another schematic diagram of another apparatus in accordance with principles of the disclosure. Elements 402-428 match elements 302-328 shown in the prior art shown in FIG. 3. In addition to elements 402-428, FIG. 4 also shows an AI-generated multi-modal system 429. This system 429 includes a model that is configured to be trained on executive or other historical communication behavior from e-mail data received from various upstream sources.

At 430, an AI generated multi-modal model is shown. Model 430 preferably may be constructed using legacy information, and constantly, or periodically, revised and/or updated based on feedback. The legacy information may include information derived from legacy executive communications.

In certain embodiments, AI Generated multi-modal model 430 gets trained on executive historical communication behavior from email data received from different upstream source servicing nodes. This information may then be fed back to one or more BOTs with relevant flagging—i.e., flagging that identifies the various developed components that can then be used for future voice overs and other responses. For the purposes of this application, automated robots (or “bots” for short) are computer programs designed to interact with human users (hereinafter, “users”) by mimicking mimic human-like behavior. Bots are typically used to automate repetitive tasks that would otherwise require a user to perform. Bots also allow users to receive service at any time, and bots may be specifically designed to accomplish specialized tasks-such as performing tasks associated with Interactive Voice Response (IVR).

Further, every input e-mail, other suitable electronic communication, may be analyzed to process different aspects and response actions from the executive in order to train the system on relevant responses. The e-mails may be flagged based on sentiment analysis to understand different responses from the sender based on received information.

At 432, The model may generate, at 432, XR-fully-assembled graphical language binary files 434. This model can generate XR fully assembled Graphical Language Binary files, which may act as a live twin with voice over of any suitable entity, for use with a virtual platform. Such voice overs—i.e., snippets of real or virtual sound files that are based on information derived from an entity such as an executive—may then be used to respond back to any sort of relevant queries.

The files may act as one or more of a group of, and preferably self-evolving, twins 436—one actual and the other synthetic. In fact, the response and e-mail metadata may be used to form the basis of digital twin behavior based on received information. The digital twin characteristics may be leveraged to form unique sequences of information associated with these twins. Each synthetic twin may be tagged to a specific entity (such as an executive) to preferably uniquely identify and uniquely modify twin actions and reactions based on executive legacy inputs. This tagging helps the twin to also identify relevant information needed for the response action based on entity (such as an executive) history.

In certain embodiments according to the disclosure, The XR environment may also transmit the information to and from the one or more internet gateways 404. Such internet gateway(s) 404 can act as bridge between wearable devices and cloud XR servers.

XR processing engine 426, according to the embodiments, can act as a dynamic decision making interactive engine for the information processing and decision verification by the digital twin. This engine also monitors the digital twin behavior for modifying the response action by updating the digital twin data in a self-learning mode.

In certain embodiments, a routing engine (not shown) may be used to index the twin and the information transmission based on generated metatags. Such metatags may be created to correspond the content and draft the initial response flag from the twin.

The response flags may be routed, via the cloud, to multiple directions. The distributed cloud sent and received information may be processed from this routing engine. Alternatively, the response flags may be routed through APIs.

The information and response tags may be transmitted through live APIs as two-way communication to form the real-time response systems and responses. Routing engine processing may include using the routing engine as a parallel processing system that channels the input information in a decentralized fashion and forms twin-based initial response flags.

A routing XR server may include output response routing via an XR server. The XR server may be verified for suitable server processing and is managed to have security layers to prevent any cross information transfer based on the twin tags.

Routing to edge devices may include sending the referenced information to edge devices or internet gateways and XR servers for processing with respect to relevant devices and environments. Accordingly, live twins 436 may act as voice overs for the executive—i.e., formulated voice signals in a virtual platform that may respond on behalf of the executive—in the place of requiring an executive, or other suitable, live response.

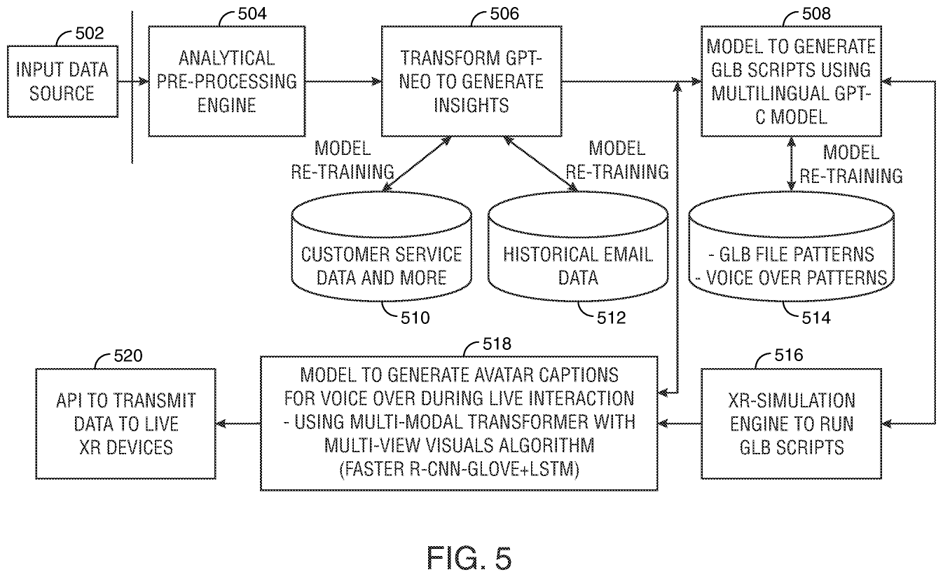

FIG. 5 shows another schematic diagram of another apparatus in accordance with principles of the disclosure. At 502, an exemplary input data source is shown. It should be noted that while this application describes input related to e-mail communication, the scope of the application should be understood to include input from all suitable forms of electronic communication channels such as text messages of all relevant types, telephone conversations, electronic chats, etc.

At 504, an analytical pre-processing engine is shown. Preferably, engine 504 is used to transform GPT-Neo to generate insights. GPT-Neo is the name of the codebase for transformer-based language models loosely styled around the GPT architecture. GPT is a transformer-based architecture and training procedure for natural language processing tasks. Such training typically follows a two-stage procedure. First, a language modeling objective is used on the unlabeled data to learn the initial parameters of a neural network model. Subsequently, these parameters are adapted to a target task using the corresponding supervised objective.

These insights may be used for model re-training focused on models related to customer service data (as shown stored in a database 510) and/or historical e-mail (or other suitable) data (as shown stored in a database 512).

In certain embodiments, the preferably current models may be used to generate GLB scripts using a multilingual GPT-C model or other suitable model, as shown at 508. The GLB file patterns and voice-over patterns may be stored in a database for future use with scripts, as shown at 514.

An XR-simulation engine 516 may be invoked to run GLB scripts as needed in interactions according to the embodiments.

At 518, the model may be used to generate avatar captions for voice over during live interaction using multi-modal transformer with a multi-view visuals algorithm. Such an algorithm may be selected from the group including faster R, CNN, Glove+LSTM or any other suitable algorithm.

At 520, an API may be invoked to transmit data to one or more live XR devices for use with systems and/or architecture according to the embodiments.

Thus, methods and apparatus for providing self-evolving virtual twins are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for providing a virtual-twin model of an individual, said virtual-twin model for use with an Interactive Voice Response (IVR) system and for implementing as part of a bot, the method utilizing a computer processor and one or more non-transitory computer-readable media storing computer executable instructions, the instructions that implement the virtual-twin model, the method comprising:
deriving legacy e-mail information from an electronic database, said e-mail information associated with an individual;
flagging a plurality of relevant components from the legacy e-mail information, said plurality of relevant components comprising response information corresponding to future voice overs for using in simulating a voice of the individual;
transmitting said flagged plurality of relevant components to the bot for updating the virtual-twin model; and
identifying a future voice over opportunity, and implementing the plurality of flagged components with respect to said future voice over opportunity; said implementing comprising using the flagged components in responding to the future voice over opportunity.

2. The method of claim 1 further comprising instantiating the plurality of flagged components as extended reality (XR)-fully-assembled graphical language binary files.

3. The method of claim 1 wherein the flagging the plurality of relevant components from the legacy e-mail information comprises flagging based on sentiment analysis of the plurality of relevant components from the legacy e-mail information, and tuning the response information corresponding to future voice overs based, at least in part, on the sentiment analysis.

4. The method of claim 1 wherein a formation of the digital twin comprises, at least in part, the flagging the plurality of relevant components from the legacy e-mail information.

5. The method of claim 1 further comprising tagging the digital twin to a specific entity.

6. The method of claim 5 further comprising using the digital twin to form unique sequences of information associated with the specific entity.

7. The method of claim 1 further comprising indexing the twin based on generated metadata tags.

8. The method of claim 7 wherein the metadata tags are configured to correspond to an initial response flag, said initial response flag being formed using the flagging the plurality of relevant components.

9. The method of claim 1 further comprising bridging the response information, said bridging using an internet gateway, from a wearable device to a plurality of cloud-based extended reality (XR) servers.

10. A digital twin system in electronic communication with a bot, said bot comprising an Interactive Voice Response system (IVR), the system comprising:
a processor,
an electronic database, for storing legacy e-mail information associated with an individual's electronic communications;
wherein the processor is configured to:
flag a plurality of relevant components from the legacy e-mail information, said plurality of relevant components comprising response information corresponding to future voice overs;
transmit said flagged plurality of relevant components to the bot for updating a virtual-twin model;
identify a future voice over opportunity;
and implement the plurality of flagged components with respect to said future voice over opportunity; said implementing comprising using the flagged components in responding to the future voice over opportunity.

11. The system of claim 10 wherein the processor is further configured to instantiate the plurality of flagged components as extended reality (XR)-fully-assembled graphical language binary files.

12. The system of claim 10 wherein the processor is further configured to flag based on sentiment analysis of the plurality of relevant components from the legacy e-mail information, and tune the response information corresponding to future voice overs based, at least in part, on the sentiment analysis.

13. The system of claim 10 wherein a formation of the digital twin comprises, at least in part, the flagging the plurality of relevant components from the legacy e-mail information.

14. The system of claim 10 wherein the processor is further configured to tag the digital twin to a specific entity.

15. The system of claim 14 wherein the processor is further configured to use the digital twin to form unique sequences of information associated with the specific entity.

16. The system of claim 10 wherein the processor is further configured to index the digital twin based on generated metadata tags.

17. The system of claim 16 wherein processor is further configured to correspond the metadata tags to an initial response flag, said initial response flag being formed using the flagging the plurality of relevant components.

18. The system of claim 10 wherein the processor is further configured to bridge the response information, using an internet gateway, from a wearable device to a plurality of cloud-based extended reality (XR) servers.

19. A digital twin system comprising:
a bot, said bot comprising an Interactive Voice Response system (IVR);
a processor, in electronic communication with the bot,
an electronic database, for storing legacy e-mail information associated with at least a portion of an individual's electronic communications;
wherein the processor is configured to:
flag a plurality of relevant components from the legacy e-mail information, said plurality of relevant components comprising response information corresponding to voice overs;
transmit said flagged plurality of relevant components to the bot for updating a virtual-twin model;
identify a future voice over opportunity; and
implement the plurality of flagged components with respect to said future voice over opportunity; said implementing comprising using the flagged components in responding to the future voice over opportunity.
